(19) United States
(12) Patent Application Publication
(10) Pub. No.: US 2010/0020445 A1
(43) Pub. Date: Jan. 28, 2010

(54) OPERATIONAL-SHOCK PERFORMANCE IN A DISK DRIVE BY MAINTAINING SERVO SIGNAL

(76) Inventor: Brian Thornton, Mountain View, CA (US)

Correspondence Address: HITACHI C/O WAGNER BLECHER LLP, 123 WESTRIDGE DRIVE, WATSONVILLE, CA, 95076, US

(21) Appl. No.: 12/180,434

(22) Filed: Jul. 25, 2008

(51) Int. Cl. G11B 5/48

(52) U.S. Cl. 360/245.3; G9B/5.147

(57) ABSTRACT

A method for maintaining a servo signal. The method includes monitoring a shock event value. The shock event value is generated by a shock sensor. The shock sensor is operably coupled with a disk drive. The disk drive is configured with an actuator arm having a suspension and slider coupled thereto. The method further includes detecting a variation in the shock event value associated with the slider. The method also includes switching from a conductive link to the slider to another conductive link to another slider, the another slider is coupled with another actuator arm in the disk drive.

### TECHNICAL FIELD

The invention relates to the field of disk drives.

### BACKGROUND ART

Direct access storage devices (DASD) are integral in everyday life, and as such, expectations and demands continually increase for greater speed for manipulating and for holding larger amounts of data. To meet these demands for increased performance, the mechano-electrical assembly in a DASD device, specifically the Hard Disk Drive (HDD) has evolved to meet these demands.

Advances in magnetic recording heads as well as the disk media have allowed more data to be stored on a disk's recording surface. The ability of an HDD to access this data quickly is largely a function of the performance of the mechanical components of the HDD. Once this data is accessed, the ability of an HDD to read and write this data quickly is primarily a function of the electrical components of the HDD.

A computer storage system may include a magnetic hard disk(s) or drive(s) within an outer housing or base containing a spindle motor assembly having a central drive hub that rotates the disk. An actuator includes a plurality of parallel actuator arms in the form of a comb that is movably or pivotally mounted to the base about a pivot assembly. A controller is also mounted to the base for selectively moving the comb of arms relative to the disk.

Each actuator arm has extending from it at least one cantilevered electrical lead suspension. A magnetic read/write transducer or head is mounted on a slider and secured to a flexure that is flexibly mounted to each suspension. The read/write heads magnetically read data from and/or magnetically write data to the disk. The level of integration called the head gimbal assembly (HGA) is the head and the slider, which are mounted on the suspension. The slider is usually bonded to the end of the suspension.

A suspension has a spring-like quality, which biases or presses the air-bearing surface of the slider against the disk to cause the slider to fly at a precise distance from the disk. Movement of the actuator by the controller causes the head gimbal assemblies to move along radial arcs across tracks on the disk until the heads settle on their set target tracks. The head gimbal assemblies operate in and move in unison with one another or use multiple independent actuators wherein the arms can move independently of one another.

To allow more data to be stored on the surface of the disk, more data tracks must be stored more closely together. The quantity of data tracks recorded on the surface of the disk is determined partly by how well the read/write head on the slider can be positioned and made stable over a desired data track. Vibration or unwanted relative motion between the slider and surface of the disk will affect the quantity of data recorded on the surface of the disk.

During disk drive operation, e.g., writing data to, reading data from or accessing data on a hard disk, a force applied to the hard disk drive may cause loss of a signal between the read/write element within the slider and the data surface of the hard disk in which data is stored.

### SUMMARY OF THE INVENTION

A method and system for maintaining a servo signal is described.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is an illustrated plan view of an HDD in accordance with an embodiment of the present invention.

FIG. 2 is an inverted illustrated view of an exemplary head gimble assembly of the HDD of FIG. 1.

FIG. 3A is a block diagram illustrating an actuator arm having two suspensions and shown relative to the data surfaces of hard disks in a disk drive, in accordance with an embodiment of the present invention.

FIG. 3B is a block diagram illustrating a plurality of actuator arms, each actuator arm having a suspension and slider, and shown relative to the data surfaces of a dual sided hard disk in a disk drive, in accordance with an embodiment of the present invention.

FIG. 4A is a block diagram of an initial operation in a method for maintaining a servo signal, in accordance with an embodiment of the present invention.

FIG. 4B is a sequential block diagram of the method for maintaining a servo signal of FIG. 4A, in an embodiment of the present invention.

FIG. 4C is a sequential block diagram of the method for maintaining a servo signal of FIG. 4B, in accordance with an embodiment of the present invention.

FIG. 4D is a sequential block diagram of the method for maintaining a servo signal of FIG. 4C, in accordance with an embodiment of the present invention.

FIG. 5 is flowchart of a process for maintaining a servo signal during disk drive operation, in accordance with an embodiment of the present invention.

FIG. 6 is block diagram of an exemplary network environment upon which embodiments of the present invention may be directed.

FIG. 7 is a block diagram of a computer system with which embodiments of the present invention may be practiced, in accordance with embodiments of the present invention.

### DETAILED DESCRIPTION

Reference will now be made in detail to embodiment(s) of the present invention. While the invention will be described in conjunction with the embodiment(s), it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, and components have not been described in detail as not to unnecessarily obscure aspects of the present invention.

Some portions of the detailed description, which follow, are presented in terms of procedures, steps, logic blocks, processing, and other symbolic representations of operations on data bits that can be performed by computer systems. These descriptions and representations are used by those skilled in the data processing arts to most effectively convey the substance of their work to others skilled in the art. A process, etc., is here, and generally, conceived to be a self-consistent sequence of operations or instructions leading to a desired result. The operations are those requiring physical manipulations of physical quantities. Usually, though not necessarily, those quantities take the form of electrical, electronic, magnetic, optical, and/or electro-optical signals, capable of being stored, transferred, combined, compared, and otherwise manipulated in a computer system. It has been proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities. Unless specifically stated otherwise, and as apparent from the following discussions, it is noted that throughout the present invention, the terms used herein refer to the action and processes of a computer system, or similar electronic computing device, that manipulates and transforms data represented as physical (electronic) quantities within the communications and computer systems' registers and memories into other data similarly represented as physical quantities within the computer system memories or registers or other such information storage, transmission, or display device.

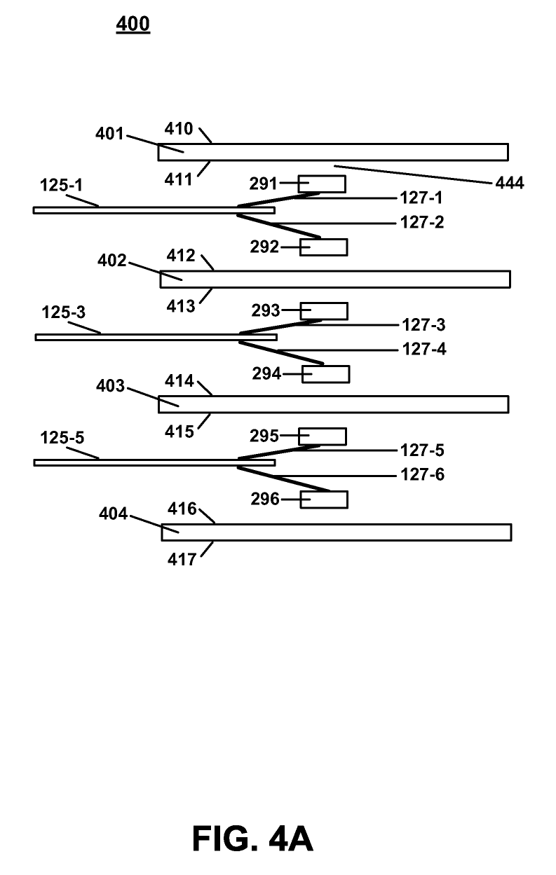

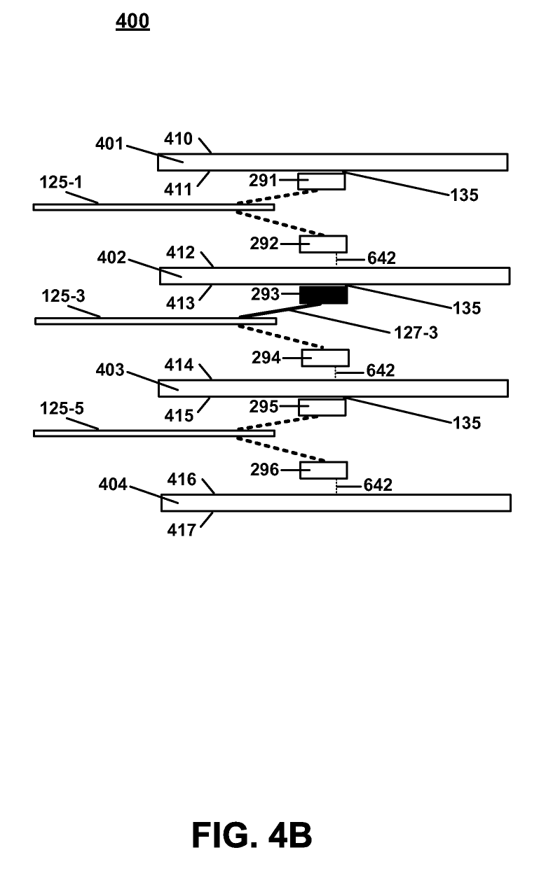

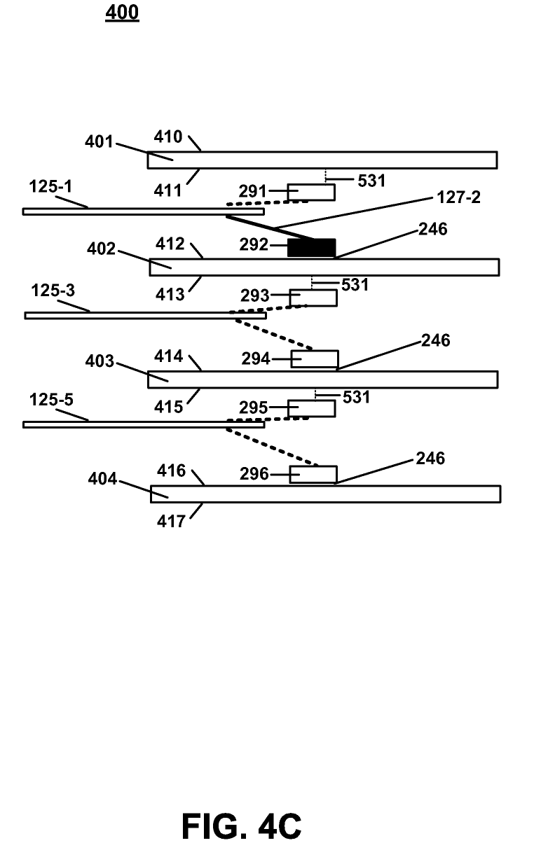

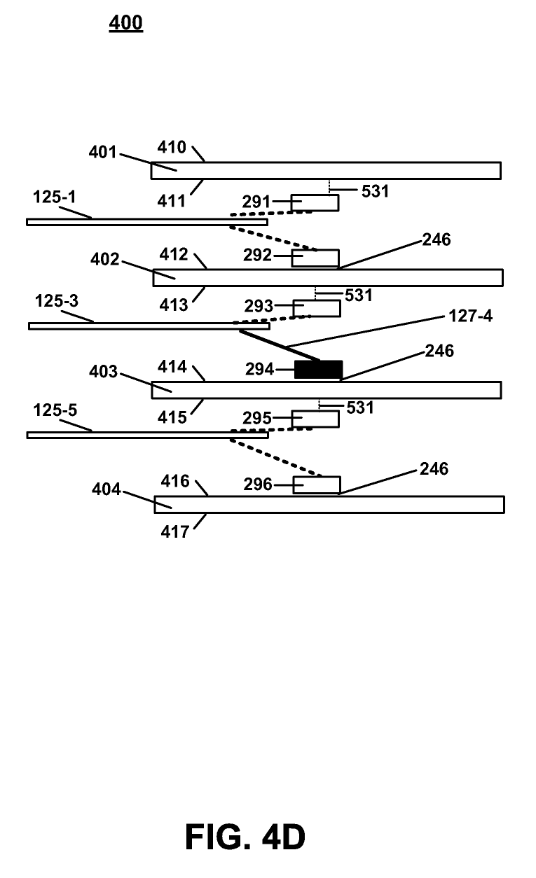

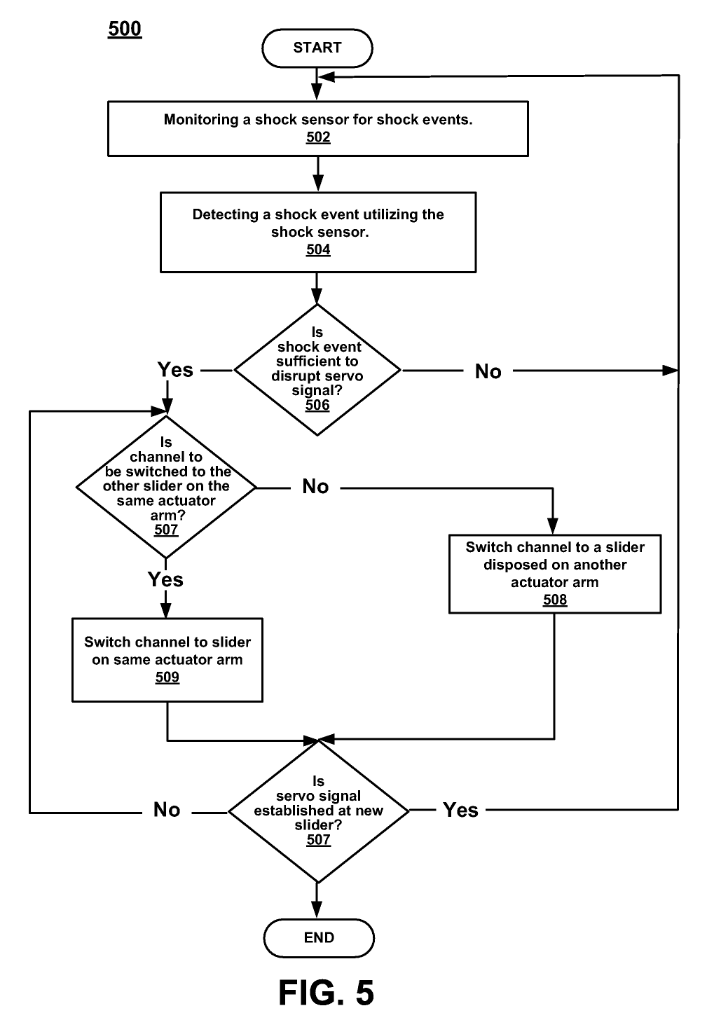

Certain portions of the detailed description of embodiments the present invention, which follow, are presented in terms of processes (e.g., process 500 of FIG. 5). These processes are, in an embodiment of the present invention, carried out by processors and electrical and electronic components under the control of computer readable and computer executable instructions. The computer readable and computer executable instructions reside, for example, in registers and other features of processors, memories, and data storage features of computers executing programs and processes. However, the computer readable and computer executable instruction may reside in any type of computer readable medium. Although specific portions are disclosed in figures herein describing the operations of processes, e.g., FIGS. 4A-4D and FIG. 5; describing processes, e.g., process 500, such portions are exemplary. That is, the present invention is well suited to performing various others portions or variations of the portions recited in the flowchart of the figures herein. Further, it is appreciated that the steps of the processes may be performed by software, firmware, hardware, or any combination of software and firmware and hardware.

### OVERVIEW

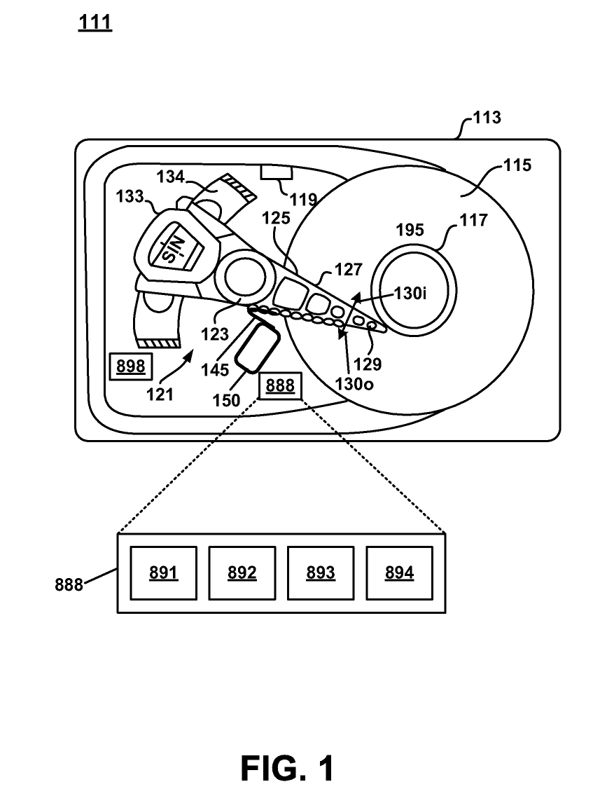

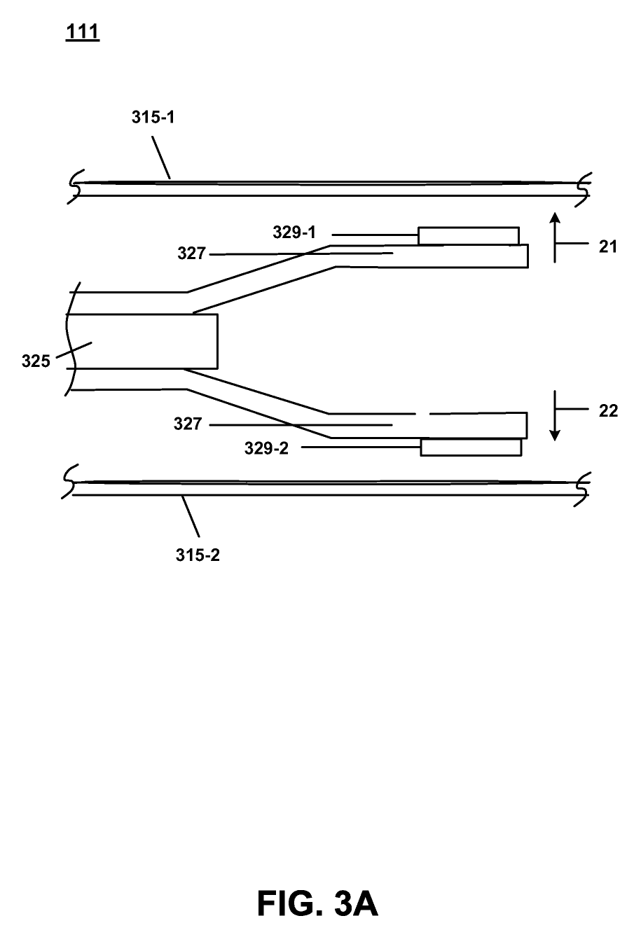

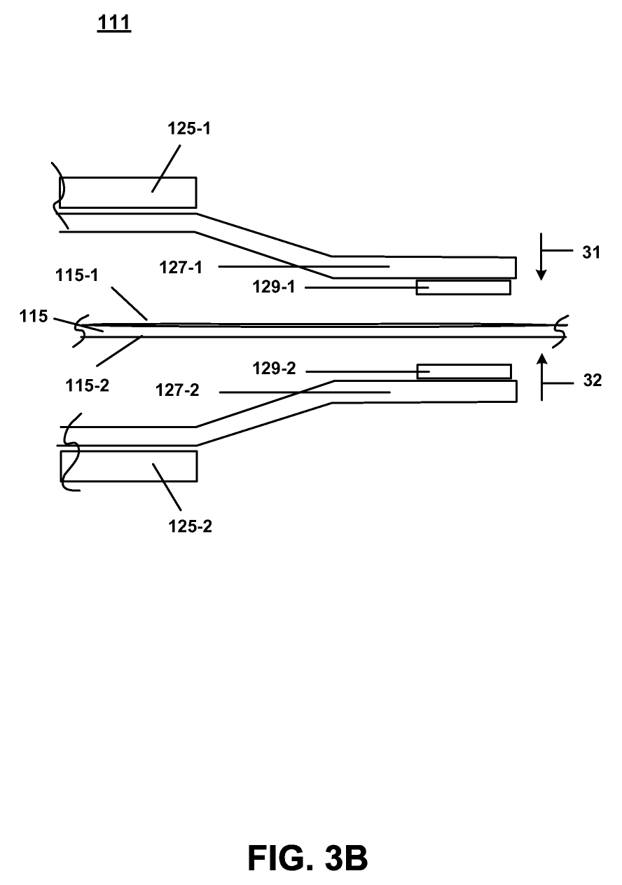

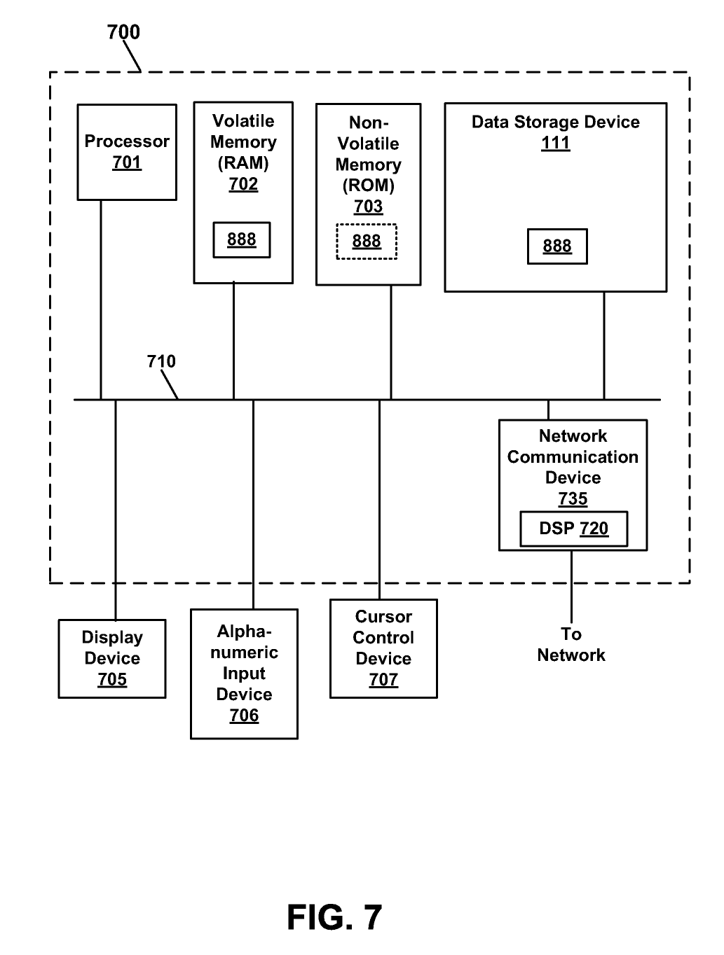

With reference now to FIG. 1, a schematic drawing of an embodiment of an information storage system comprising a magnetic hard disk file or hard disk drive (HDD) 111 for a computer system, e.g., data storage device 704 of computer system 700 of FIG. 7, is shown. HDD 111 has an outer housing or base 113 containing a disk pack having at least one media or magnetic disk 115. Not shown is a cover, mated to housing 113, that, when installed, provides a sealed housing 113. A spindle motor assembly having a central drive hub 117 rotates the disk or disks 115, as indicated by arrow 195. In an embodiment of the present invention, the spindle motor assembly may be configured with a fluid dynamic bearing (not shown). Other disk drive spindle motor assemblies may utilize alternative bearing systems. In the drive shown, disks 115 may be configured with a data storage surface on each disk side, as shown and described herein with reference to FIGS. 3A and 3B, FIGS. 4A-4D, and FIGS. 5, in accordance with embodiments of the present invention. An actuator 121 comprises a plurality of parallel actuator arms 125 (one visible in the shown perspective) in the form of a comb that is movably or pivotally mounted to base 113 about a pivot assembly 123. A controller 119 is also mounted to base 113 for selectively moving the comb of arms 125 relative to disk 115.

In an embodiment of the present invention, HDD 111 includes a servo shock monitoring system, e.g., SSMS 888. SSMS 888 is shown to include a servo shock sensor 898. In an embodiment of the present invention, servo shock sensor 890 may be coupled with and configured to monitor fluid pressure within a fluid dynamic bearing, such that a change in pressure is sensed, indicative of an external motion or shock. In another embodiment of the present invention, servo shock sensor 890 may be coupled with and configured to monitor a measuring sensor, e.g., a laserometer or similar distance measuring device, coupled to HDD 111, that measures the distance between a slider and a data storage surface of a hard disk 115, e.g., clearances 135, 246, 444, 531 and 641, other distance, as described herein with reference to FIG. 3 and FIGS. 4A-4D. In yet another embodiment of the present invention, servo shock sensor 890 may be coupled to and configured to monitor an electronic sensor, coupled to HDD 111, which provides a measurable quantity or value, e.g., signal strength, frequency response, etc. In the present embodiment, servo shock sensor 898 is a fluid pressure sensor that utilizes fluid pressure within a chamber to detect a shock or other motion event.

In an embodiment of the present invention, SSMS 888 also includes a circuit rerouter 891. In an embodiment of the present invention, circuit rerouter 891 is configured to cause a rerouting of the communicative and electrical signal from a processing slider to a non-processing slider, as described herein with reference to FIGS. 3A-3B, FIGS. 4A-4D, and FIG. 5, such that the non-processing slider becomes the processing slider.

In an embodiment of the present invention, SSMS 888 further includes a rerouter signal verifier 892. In an embodiment of the present invention, rerouter signal verifier 892 is configured to verify that a servo signal can be established utilizing a selected another suspension. Rerouter signal verifier 892 is further configured to verify that the servo signal has been reestablished subsequent to a circuit rerouting process, as described herein with reference to FIGS. 3A, 3B, 4A-4D, and 5.

In an embodiment of the present invention, SSMS 888 is shown to also include a servo unlock overrider 893. In an embodiment of the present invention, servo unlock overrider 893 is configured to take control of actuator arm assembly 125 motion prior to a servo unlock process as described herein with reference to FIGS. 3A, 3B, 4A-4D and FIG. 5.

Still referring to FIG. 1, although embodiments of the present invention depict SSMS 888 and servo shock sensor 898 as independently implemented within HDD 111, SSMS 888 may be incorporated into existing integrated circuit components, e.g., actuator 121, controller 119, etc. SSMS 888 and servo shock sensor 898 may be singularly or combinationally disposed within integrated circuits operable within HDD 111. In another embodiment of the present invention, SSMIS 888 may be wholly or combinationally disposed in other components and devices, e.g., and with reference to FIG. 7, in data storage device 704, in non-volatile memory 703, indicated by dashed line 881, and/or in volatile memory 702, indicated by dotted line 882 (during disk drive operation). SSMS 888 may also be distributed across a network environment, e.g., client computer systems 790 and/or 791 and/or server computer system 792 of network 700 of FIG. 7.

In an embodiment of the present invention, each actuator arm 125 may have extending from it a cantilevered electrical lead suspension (ELS) 127 (load beam removed), as shown in FIG. 3B. In another embodiment of the present invention, each actuator arm 125 may have extending from it multiple cantilevered electrical lead suspensions (ELS) 127 (load beam removed), as shown in FIG. 3A and FIGS. 4A-4D. It should be understood that ELS 127 may be, in one embodiment, an integrated lead suspension (ILS) that is formed by a subtractive process. In another embodiment, ELS 127 may be formed by an additive process, such as a Circuit Integrated Suspension (CIS). In yet another embodiment, ELS 127 may be a Flex-On Suspension (FOS) attached to base metal or it may be a Flex Gimbal Suspension Assembly (FGSA) that is attached to a base metal layer. The ELS may be any form of lead suspension that can be used in a Data Access Storage Device, such as a HDD.

A magnetic read/write transducer or head is mounted on a slider 129 and secured to a flexure that is flexibly mounted to each ELS 127. The read/write heads magnetically read data from and/or magnetically write data to disk 115. The level of integration called the head gimbal assembly (HGA) is the head and the slider 129, which are mounted on suspension 127. The slider 129 may be bonded to the end of ELS 127. Alternatively, a secondary actuating mechanism may be interposed between slider 129 and ELS 127

With reference still to FIG. 1, ELS 127 has a spring-like quality, which biases or presses the air-bearing surface of the slider 129 against the disk 115 to cause the slider 129 to fly at a precise distance from the disk surface, termed flying height. ELS 127 has a hinge area that provides for the spring-like quality, and a flexing interconnect (or flexing interconnect) that supports read and write traces through the hinge area. A voice coil 133, free to move within a conventional voice coil motor magnet assembly 134 (top pole not shown), is also mounted to arms 125 opposite the head gimbal assemblies. Movement of the actuator 121 by controller 119 causes the head gimbal assemblies to move along radial arcs (inwardly as indicated by arrow 130i and outwardly as indicated by arrow 130o) across tracks on the disk 115 until the heads settle on their set target tracks. In an embodiment of the present invention, the head gimbal assemblies of HDD 111 operate and move in unison with one another. In an alternative embodiment of the present invention, the head gimble assemblies of HDD 111 are configured with multiple independent actuators (not shown), wherein the arms can move independently of one another.

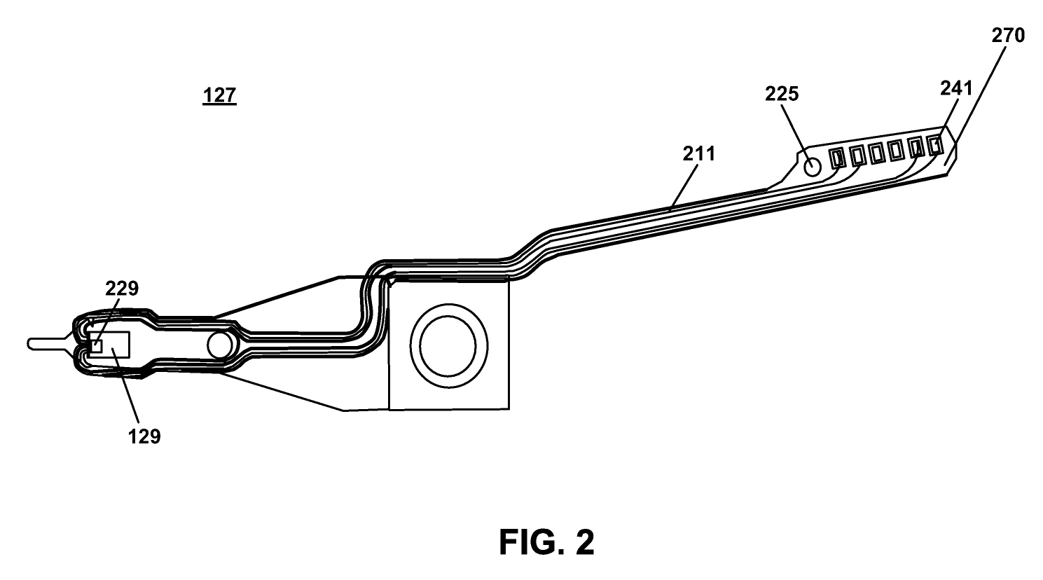

HDD 111 further includes an AE bracket 150 having coupled thereto a flexible cable 145. Flexible cable 145 is mounted to actuator arms 125. Solder pads disposed on flexible cable 145 (not shown) are alignable with solder pads disposed on a HGA, e.g., solder pad 241 of FIG. 2, thus enabling an electrical and communicative link between slider 129 and actuator 121.

FIG. 2 is an inverted illustrated view of the HGA 127 of FIG. 1. HGA 127 includes a plurality of layers, although a base layer 270 is visible from this perspective. Disposed at one end of HGA 127 is slider 129. Disposed within or coupled to slider 129 is a read/write head 229, for effecting change or accessing data stored on a hard disk 115.

Disposed at the opposite end of HGA 127 is a tail section that is shown to include an alignment hole 225 for aligning HGA 127 with actuator arm 125 during assembly. Also shown is a plurality of solder pads 241. A communication line 211 is shown coupled to a solder pad 241 and coupled to slider 129, providing an electrical path from slider 129 to tail portion 245.

It is noted that although embodiments of the present invention are discussed in conjunction with an ELS 127 having six solder pads 241, of which four are shown coupled to connector wires 211, the numbers of wires and pads is purely exemplary and is not to be construed as a limitation. In alternative embodiments of the present invention, there may be a greater number or a lesser number of solder pads 241 and/or a greater number or lesser number of connector wires 211. There may also be a greater number or lesser number of connector wires 211 coupled to solder pads 241.

FIG. 3A is a block diagram of an actuator arm 325 configured with two suspensions 327 in which each suspension 327 includes a slider 329, shown in relation to hard disks 115 in HDD 111, as described herein with reference to FIGS. 1 and 2, in accordance with embodiments of the present invention. FIG. 3A includes a hard disk 315-1 and a hard disk 315-2. In an embodiment of the present invention, hard disks 315-1 and 315-2 include a data storage surface on each disk side, such that data may be written to, read from or accessed on either side of hard disk 115, as described herein with reference to FIGS. 4A-4D and FIG. 5, in accordance with embodiments of the present invention.

An actuator arm 325 is shown interposed between hard disk 315-1 and 315-2. Actuator arm 325 is shown to have two coupled suspensions 327 extending there from. A slider 329 is coupled to each suspension 327, e.g., slider 329-1 and slider 329-2. In the present embodiment, slider 329-1 is associated with hard disk 315-1 and slider 329-2 is associated with hard disk 315-2.

Still referring to FIG. 3A, during manufacturing of disk drive 111, disks 315-1 and 315-2 are subject to a servo writing process, where servo information is written onto the hard disk. Servo information can include, but is not limited to, a gain control field for read signal strength adjustment, a sync field for establishing timing references for the circuits of the drive, e.g., controller 119 and actuator 121, an identification field for providing sector and track identification, and a servo field that contains bits that are read and used to position slider 329 over the intended target location on the disk surface, e.g., a servo signal.

With reference still to FIG. 3A, during a read or access operation, the read element in slider 329 senses the magnetized servo fields of the disks, e.g., detects a servo signal that is returned to controller 119, interpreted, and then dictates the motion of slider 329 to the intended target location. During slider 329 motion, e.g., inwardly as indicated by arrow 130i or outwardly as indicated by arrow 130o, the servo signals emanating from locations over which slider 329 is moving are read and interpreted by actuator 121 to determine where slider 329 is in relation to the intended target location, and where slider 329 needs to be to read/write/access the intended data target location.

If slider 329-1 is the processing slider, meaning that slider 329-1 is being used to read/write/access data, the distance from slider 329-1 to the data storage surface of the disk is reduced to what is termed operational flying height, as indicated by arrow 21. Operational flying height is the distance between the slider and the data storage surface that enables slider 329-1 to detect the servo signal, as well as to read/write/access data on a disk 315-1. In the present embodiment, that same motion causes the distance between slider 129-2 and hard disk 315-2 to increase, as described herein with reference to FIGS. 4A-4D and FIG. 5. Conversely, if slider 329-2 is the processing slider, slider 329-2 is moved closer to hard disk 315-2 and slider 329-1 is accordingly moved farther away from disk 315-1, as indicated by arrow 22.

While a slider 329-1 is processing and a motion or shock event occurs, if the servo signal is lost, e.g., no longer at the operational flying height, the actuator becomes unstable. Remaining current to a voice coil motor can cause an unload if the slider is moving outwardly (arrow 130o, FIG. 1) or actuator will contact inside diameter crash stop if moving inwardly (arrow 130i, FIG. 1). Embodiments of the present invention are enabled to protect the data storage surface and the slider from contact damage during the shock event. In accordance with an embodiment of the present invention, SSMS 888 is configured to interact with integrated circuits of HDD 111, e.g., 119, 121, 150, etc., such that SSMS 888 assumes control of and/or provides instructions to actuator 121 for controlling the movement of actuator arm assembly 325.

FIG. 3B is a block diagram of a hard disk drive 111 configured with a single dual sided hard disk 115 and a plurality of actuator arms 125, each configured with a suspension 127 and a slider 129, and shown in relation to the hard disk, as described herein with reference to FIGS. 1 and 2, in accordance with an embodiment of the present invention. FIG. 3B includes a hard disk 115 configured with a data storage surface on each disk side, e.g., data storage surface 115-1 and a data storage surface 115-2, such that data may be written to, read from or accessed on either side of hard disk 115, as described herein with reference to FIGS. 4A-4D and FIG. 5, in accordance with embodiments of the present invention.

In the present embodiment, hard disk 115 is shown interposed between a plurality of actuator arms, e.g., actuator arms 125-1 and 125-2. Actuator arm 125-1 is shown to include a suspension 127-1, extending there from, and a slider 129-1 is coupled to suspension 127-1. Actuator arm 125-2 is shown to include a suspension 127-1, extending there from, and a slider 129-2 is coupled to suspension 127-2. In the present embodiment, slider 129-1 is associated with data storage surface 115-1 and slider 129-2 is associated with data storage surface 115-2 of hard disk 1 15.

Still referring to FIG. 3B, during manufacturing of disk drive 111, disk 115 is subject to a servo writing process, where servo information is written onto the hard disk. Servo information can include, but is not limited to, a gain control field for read signal strength adjustment, a sync field for establishing timing references for the circuits of the drive, e.g., controller 119 and actuator 121, an identification field for providing sector and track identification, and a servo field that contains bits that are read and used to position slider 129-1 or 129-2 over the intended target location on the disk surface, e.g., a servo signal.

With reference still to FIG. 3B, during a read or access operation, the read element in slider 129-1 or slider 129-2 senses the magnetized servo fields of the disks, e.g., detects a servo signal that is returned to controller 119, interpreted, and then dictates the motion of slider 129-1 or slider 129-2 to the intended target location. During slider 129-1 or slider 129-2 motion, e.g., inwardly as indicated by arrow 130i or outwardly as indicated by arrow 130o, the servo signals emanating from locations over which slider 129-1 or slider 129-2 is moving are read and interpreted by actuator 121 to determine where slider 129-1 or slider 129-2 is in relation to the intended target location, and where slider 129-1 and slider 129-2 needs to be to read/write/access the intended data target location.

If slider 129-1 is the processing slider, meaning that slider 129-1 is being used to read/write/access data, the distance from slider 129-1 to the data storage surface of the disk, e.g., 115-1 of 115, is reduced to what is termed operational flying height, as indicated by arrow 31. Operational flying height is the distance between the slider and the data storage surface that enables slider 129-1 to detect the servo signal, as well as to read/write/access data on data storage surface 115-1 of disk 115. In the present embodiment, orienting slider 129-1 to a flying height causes the distance between slider 129-2 and data storage surface 115-2 of disk 115 to increase, as described herein with reference to FIGS. 4A-4D and FIG. 5. Conversely, if slider 129-2 is the processing slider, slider 129-2 is moved closer to data storage surface 115-2 of disk 115, and slider 129-1 is accordingly moved farther away from data storage surface 115-1 of disk 115, as indicated by arrow 32.

While slider 129-1 is processing and a motion or shock event occurs, if the servo signal is lost, e.g., no longer at the operational flying height, the actuator becomes unstable. Remaining current to a voice coil motor can cause an unload if the slider is moving outwardly (arrow 130o, FIG. 1) or actuator will contact an inside diameter crash stop if moving inwardly (arrow 130i, FIG. 1). Embodiments of the present invention are enabled to protect the data storage surface and the slider from contact damage during the shock event. In accordance with an embodiment of the present invention, SSMS 888 is configured to interact with integrated circuits of HDD 111, e.g., 119, 121, 150, etc., such that SSMS 888 assumes control of and/or provides instructions to actuator 121 for controlling the movement of actuator arm assembly 125.

FIG. 4A is an initial cross sectional block diagram of an actuator arm/suspension assembly relative to the hard disk(s) in a hard disk drive environment and in conjunction with a process 500 for maintaining a servo signal during a shock event, as described herein with reference to FIG. 5, in accordance with an embodiment of the present invention. Environment 400 includes a plurality of hard disks, e.g., hard disks 401-404. Hard disks 401-404 are functionally analogous to hard disks 115 of FIG. 1. Hard disks 401, 402, 403 and 404 are shown to have dual sided data storage functionality, such that each side of the disk is configured with a data storage surface, e.g., data storage surfaces 410-411, 412-413, 414-415 and 416-417, respectively, in an embodiment of the present invention.

Environment 400 further includes three actuator arms, e.g., 425-1, 425-3 and 425-5, each of which are configured with two suspensions, e.g., arm 425-1 having coupled thereto suspensions 427-1 and 427-2, arm 425-3 having coupled thereto suspensions 427-3 and 427-4 and arm 425-5 having coupled thereto suspensions 427-5 and 427-6, in accordance with an embodiment of the present invention, as described herein with reference to FIGS. 1, 2 and 3A. In the present embodiment, each suspension slider 491-496 is coupled to a suspension 427-1, 427-2, 427-3, 427-4, 427-5 and 427-6, respectively. Actuator arms 425-1, 425-3 and 425-5, suspensions 427-1 to 427-6 and sliders 491-496 are analogous to actuator arm 125, suspension 127, and slider 129 of FIGS. 1 and 2, and are hereby incorporated by reference.

In the present embodiment, slider 491 is configured to read/write/access data on data storage surface 411 of disk 401. In the present embodiment, slider 492 is configured to read/write/access data on data storage surface 412 of disk 402. In the present embodiment, slider 493 is configured to read/write/access data on data storage surface 413 of disk 402. In the present embodiment, slider 494 is configured to read/write/access data on data storage surface 414 of disk 403. In the present embodiment, slider 495 is configured to read/write/access data on data storage surface 411 of disk 403. In the present embodiment, slider 496 is configured to read/write/access data on data storage surface 416 of disk 404.

Although embodiments of the present invention are shown implemented in a disk drive 111 that is configured with four hard disks and three actuator arm assemblies, it is noted that embodiments of the present invention are well suited for utilization in hard disk drives with a greater number or lesser number of hard disks as well as hard disk drives having a greater number or lesser number of actuator arm assemblies. As such, hard disk drives shown and described herein, and upon which embodiments of the present invention may be practiced, are exemplary in nature are not to be construed as a limitation.

FIG. 4B is a sequential cross-sectional block diagram of environment 400 of FIG. 4A in an embodiment of the present invention. In an example of an embodiment of the present invention, data is to be written to and/or read from and/or accessed on data storage surface 413 of hard disk 402, and as such, slider 493 is the processing slider, as indicated in grey. Accordingly, the communicative and electronic channel between slider 493 and actuator 121 is routed through actuator arm 425-3 and suspension 427-3, in an embodiment of the present invention. As actuator arms 425-1, 425-3 and 425-5 are, in the present embodiment, configured to move in unison, slider 291, and accordingly sliders 493 and 495, have been repositioned from a non-processing position, e.g., distance 444 of FIG. 4A, into a processing position, such that sliders 491, 493 and 495 are at an operational flying height, indicated by distance 135, in an embodiment of the present invention.

In the processing position as shown, slider 493 may read/write/access data on data storage surface 413 of disk 402. Alternatively, and from the same distance, distance 135, slider 491 may read/write/access data on data storage surface 411 of disk 401 and accordingly slider 495 may read/write/access data on data storage surface 415 of disk 403, dependent upon the location of data to be read, written, or accessed. By virtue of actuator arms 425-1, 425-3 and 425-5 being configured with multiple suspensions, sliders 492, 494 and 496 are conversely at a greater distance from a data storage surface of a hard disk, indicated by clearance 642.

Still referring to FIG. 4B, during a read/write/access process being performed by slider 493, slider 493 senses the servo signal present on data storage surface 413, as described herein with reference to FIG. 3A and FIG. 3B. When a force, e.g., a shock or other motion, applied to HDD 111 is detected by servo shock sensor 898 of HDD 111, servo shock sensor 898 causes a shock event indicator to be sent to servo shock monitor 888 (FIGS. 1, 6 and 7). In an embodiment of the present invention, subsequent to receiving a shock event indicator, servo shock monitor 888 determines if slider 493 remains at operational flying height, e.g., distance 135.

In an embodiment of the present invention, if distance 135 is substantially unchanged, such that continued flying height is not in jeopardy, servo shock monitor 888 continues monitoring. However, if distance 135 increases as a result of the shock event, such that the servo signal may be lost by slider 493 or if distance 135 has decreased, such that slider contact with a disk surface, e.g., slider 493 contacting data storage surface 413, may occur, servo shock monitor 888 may, in an embodiment of the present invention, invoke servo unlock overrider 893.

With reference still to FIG. 4B, in an embodiment of the present invention, invocation of servo unlock overrider 893 prevents actuator unload and/or actuator crash stop, as described herein with reference to FIGS. 3A and 3B, such that SSMS 888 takes control of operations and communications associated with slider 493 of a suspension 427-3 of actuator arm 425-3.

In an embodiment of the present invention, and subsequent to SSMS 888 gaining conductive link control, circuit rerouter 891 determines to which the electrical and communicative channel is to be switched, such that processing slider 493 is no longer the processing slider and that an alternative non-processing slider becomes the processing slider. In accordance with an embodiment of the present invention, circuit rerouter 891 may select slider 492 or slider 494 or slider 496.

In an embodiment of the present invention, circuit rerouter 891 may select the other slider mounted to the actuator arm having slider 493, such that slider 494 becomes the processing slider. In another embodiment of the present invention, circuit rerouter 891 may select a slider on a different actuator arm, e.g., slider 492 or slider 496, such that slider 492 or slider 496 becomes the processing slider.

FIG. 4C is a sequential block diagram of FIG. 4B in an embodiment of the present invention. In the present embodiment, circuit rerouter 891 selects slider 492 as the now processing slider. Accordingly, circuit rerouter 891 enables the communicative and electrical connection for the appropriate actuator arm associated with slider 492, e.g., suspension 427-2, and, as such, also disables the communicative and electrical connection for slider 493, e.g., suspension 427-3. In accordance with an embodiment of the present invention, slider 492 is oriented into an operational flying height, as indicated by distance 246 and accordingly becomes the processing slider, as indicated by a shaded slider 492.

FIG. 4D is a sequential block diagram of FIG. 4C, in another embodiment of the present invention. In the present embodiment, circuit rerouter 891 selects slider 494 as the now processing slider. Accordingly, circuit rerouter 891 enables the communicative and electrical connection for the appropriate actuator arm associated with slider 494, e.g., suspension 427-4, and, as such, also disables the communicative and electrical connection for slider 493, e.g., suspension 427-3. In accordance with an embodiment of the present invention, slider 494 is oriented into an operational flying height, as indicated by distance 246 and accordingly becomes the processing slider, as indicated by a shaded slider 494.

Referring collectively to FIGS. 4C and 4D, in an embodiment of the present invention, prior to circuit rerouter 891 initiating a channel switch, rerouted signal verifier 892 verifies that the channel associated with the to be processing slider is functional and operational. In an embodiment of the present invention and subsequent to circuit rerouter 891 causing a channel switch, rerouted signal verifier 892 verifies that the processing slider, e.g., slider 493 or slider 494, is able to sense the servo signal on the associated data storage surface, e.g., surface 413 or 414, respectively.

FIG. 5 is a flowchart of a process 500 for maintaining a servo signal in accordance with various embodiments of the invention. Process 500 includes exemplary operations of various embodiments of the invention which can be carried out by a processor(s) and electrical components under the control of computing device readable and executable instructions (or code), e.g., SSMS 888. The computing device readable and executable instructions (or code) may reside, for example, in data storage features such as volatile memory, non-volatile memory and/or mass data storage that are usable by a computing device. However, the computing device readable and executable instructions (or code) may reside in any type of computing device readable medium. Although specific operations are disclosed in process 500, such operations are exemplary. That is, process 500 may not include all of the operations illustrated by FIG. 5. Also, process 500 may include various other operations and/or variations of the operations shown by FIG. 5. Likewise, the sequence of the operations of process 500 can be modified. It is noted that the operations of process 500 can be performed by software, by firmware, by hardware, or by any combination thereof.

Process 500 for maintaining a servo signal will be described with reference to components and devices shown in FIGS. 1, 2, 3A, 3B, FIGS. 4A-4D, in accordance with embodiments of the present invention.

In operation 502 of process 500, disk drive 111 is operating and a slider of disk drive 111 is actively processing, e.g., reading data from, writing data to, or accessing data on a data storage surface of a hard disk, e.g., slider 493 of suspension 427-3, as described herein with reference to FIG. 4A and FIG. 4B or slider 129-1 of suspension 127-1 of actuator arm 125-1 of disk drive 111 of FIG. 3B. In accordance with an embodiment of the present invention, concurrent with disk drive 111 in operation, a servo shock monitoring system is operational and actively monitoring for shock events, e.g., SSMS 888 of FIG. 1.

In operation 504 of process 500, shock sensor 898 detects a shock event, e.g., a motion or force applied to the disk drive. In an embodiment, SSMS 888 may be coupled to a shock sensor, e.g., shock sensor 898 of FIG. 1. In an embodiment of the present invention, shock sensor 898 may be configured to measure distance between a slider and the data storage surface from which the slider is reading or accessing data and to which data is written by the slider, e.g., slider 493 of FIG. 4B or slider 129-1 of FIG. 3B. In an alternative embodiment of the present invention, shock sensor 898 may be configured to monitor fluid pressure, e.g., fluid in a fluid dynamic bearing. In yet another embodiment of the present invention, shock sensor 898 may be configured to monitor strength of servo signal emitted from the data storage surface and sensed by a slider.

In operation 506 of process 500, subsequent to a shock event being detected, SSMS 888 determines if the shock event is sufficient enough to disrupt the servo signal emitted by the data storage surface of the hard disk and sensed by the processing slider, e.g., slider 493 of FIG. 4B and/or slider 129-1 of FIG. 3B, in an embodiment of the present invention. In an embodiment of the present invention, if the detected shock event is not sufficient to disrupt the servo signal, process 500 reverts back to operation 502 and continues monitoring. In an alternative embodiment of the present invention, SSMS 888 may invoke an unlocking overrider, e.g., servo unlock overrider 893 to prevent disk drive 111 from performing an unload process and/or a ID crash stop process, as described herein with reference to FIG. 1. In the present embodiment, if the detected shock event disrupts slider 493 sensing of the servo signal, process 500 proceeds to operation 507.

In operation 507 of process 500, SSMS 888 may invoke a circuit rerouter e.g., circuit rerouter 891 to switch the communicative and electronic channel from the processing slider, e.g., slider 493, to another slider, e.g., slider 492, 494 or 496, in an embodiment of the present invention. Circuit rerouter 891 determines if the new channel to utilize is part of the actuator arm on which slider 493 is mounted, e.g., actuator arm 425-3. If the channel to be utilized is disposed on an actuator arm not configured with slider 493/129-1, e.g., actuator arms 425-1 and 425-5 of FIGS. 4A-4D and actuator arm 127-2 of FIG. 3B, respectively, process 500 proceeds to operation 508. If the channel to be utilized is disposed on the same actuator arm as slider 493, process 500 proceeds to operation 509.

In operation 508 of process 500, circuit rerouter 891 selects an actuator arm not having the processing slider, e.g., actuator arm 425-1 for slider 492 of FIG. 4C and actuator arm 125-2 for slider 129-2 of FIG. 3B, in accordance with an embodiment of the present invention. As such, slider 492/129-2 will be the processing slider. In an embodiment of the present invention, circuit rerouter 891 enables the communicative and electrical connection for the appropriate actuator arm associated with slider 492, e.g., suspension 427-2 of FIG. 4C, and/or slider 129-2, e.g., suspension 127-2 of FIG. 3B, and accordingly, disables the communicative and electrical connection for slider 493, e.g., suspension 427-3 of FIG. 4B and/or slider 129-1 of suspension 127-1 of FIG. 3B. In accordance with an embodiment of the present invention, slider 492/129-2 is/are oriented into an operational flying height, as indicated by distance 246 (FIG. 4C) and accordingly becomes the processing slider, as indicated by a shaded slider 492 as described herein with reference to FIG. 4D.

In operation 509 of process 500, circuit rerouter 891 selects slider 494 as the now processing slider. Accordingly, circuit rerouter 891 enables the communicative and electrical connection for the appropriate actuator arm associated with slider 494, e.g., suspension 427-4, and, as such, also disables the communicative and electrical connection for slider 493, e.g., suspension 427-3. In accordance with an embodiment of the present invention, slider 494 is oriented into an operational flying height, as indicated by distance 246 and accordingly becomes the processing slider, as indicated by a shaded slider 494 as described herein with reference to FIG. 4D

In process 510 of process 500, a rerouted signal verifier, e.g., rerouter signal verifier 892 verifies that the communicative and electronic channel now being used in conjunction with now processing slider, e.g., slider 493 of FIG. 4C or slider 494 of FIG. 4D or slider 129-2 of FIG. 3B, is functioning. If the channel is functioning, process 500 returns to operation 502 and resumes monitoring, in an embodiment of the present invention. If the channel is not functioning, process 500 returns to operation 507. It is noted that subsequent to completion of operation 510, process 500 may be also terminated.

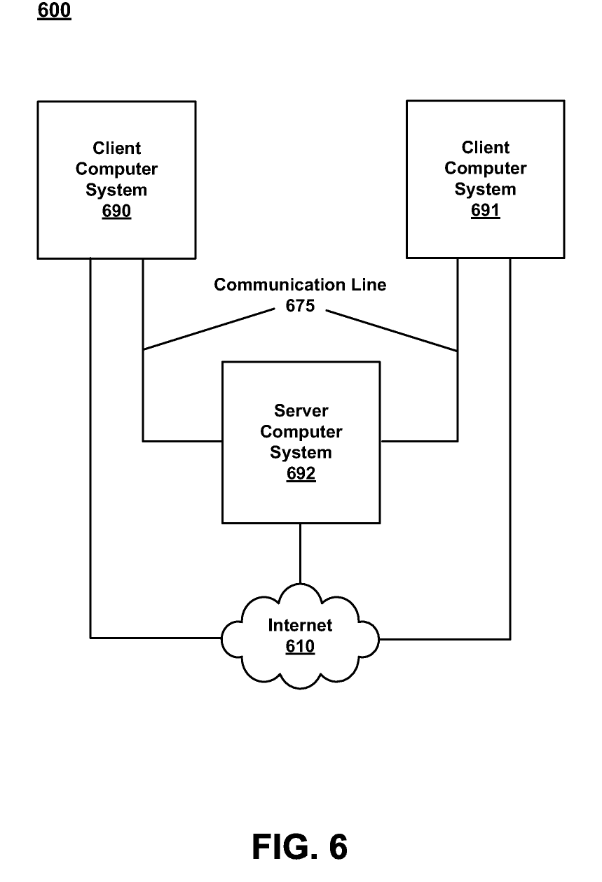

FIG. 6 is a block diagram illustrating an exemplary client-server computer system network, e.g., network 600, upon which embodiments of the present invention may be practiced. Network 600 may be a communication network located within a firewall of an organization or corporation (an “Intranet”), or network 600 may represent a portion of the World Wide Web or Internet. Client (or user) computer systems 690 and 691 and server computer system 692 are communicatively coupled via a communication line 675; the mechanisms for coupling computer systems over the Internet or over Intranets are well known in the art. This coupling can be accomplished over any network protocol, wired or wireless, that supports a network connection, such as IP (Internet Protocol), TCP (Transmission Control Protocol), UDP (User Datagram Protocol), TELNET, NetBIOS, IPX (Internet Packet Exchange), IR (infra red), RF (radio frequency), wireless broadband, Bluetooth, LU6.2, and link layers protocols such as Ethernet, token ring, and ATM (Asynchronous Transfer Mode). Alternatively, client computer systems 690 and 692 can be coupled to server computer system 691 via an input/output port (e.g., a serial port) of server computer system 691; that is, client computer systems 690 and 691 and server computer system 692 may be non-networked devices. It is appreciated that, for simplicity, only two client computer systems and a single server computer system are shown; however, it is understood that network 600 may comprise any number of client computer systems and server computer systems.

FIG. 7 is a block diagram illustrating components and circuitry of an exemplary computer system 700, which can be implemented within a client computer system, e.g., client computer system 690 and/or 691, and in a server computer system, e.g., server computer system 692, of FIG. 6, upon which embodiments of the present invention may be practiced. Computer system 700 includes an address/data bus 710 for communicating information, a central processor 701 coupled with the bus for processing information and instructions, a volatile memory 702 (e.g., random access memory, RAM) coupled with the bus 710 for storing information and instructions for the central processor 701 and a non-volatile memory 703 (e.g., read only memory, ROM) coupled with the bus 710 for storing static information and instructions for the processor 701. Optionally, computer system 700 can include dynamic ROM (DROM, not shown). It is noted that in an embodiment, computer system 700 can be configured with a plurality of processors 701.

Computer system 700 of FIG. 7 also includes a data storage device 704, e.g., disk drive 111 of FIG. 1, coupled with bus 710 for storing instructions and information. In the present embodiment, data storage device 704 is analogous to disk drive 111 of FIG. 1, which is incorporated herein by reference. Data storage device 704 also includes a set of instructions for maintaining a servo signal, e.g., SSMS 888, in accordance with an embodiment of the present invention. SSMS888 is enabled to interpret readings provided by a servo shock sensor, e.g., sensor 898, and provide switching of the servo signal from one slider to another, in accordance with an embodiment of the present invention, as described herein with reference to FIGS. 3A and 3B, FIGS. 4A-4D and FIG. 5.

By virtue of the desire to maintain a servo signal, it is noted that instructions 777 are stored within a data storage device, e.g., 204, in which data is stored in a relatively permanent environment. However, in an alternative embodiment, portions of instructions 777 may be combinationally distributed among non-volatile memory, e.g., ROM 703 and a data storage device 704. Data storage device 704 can be, for example, an HDD (hard disk drive), an FDD (floppy disk drive), a compact memory device, a CD-RW (compact disk with write functionality), a DVD-RW or DVD+RW (digital versatile disk with+or- write functionality), a dual layer DVD, a tape drive, a USB drive, etc., and furthermore device 704 can be in multiples or in a combination thereof. Data storage device 704 may also be local or remote to the computer system, plurally instanced, removable, and/or hot swappable (connected or unconnected while computer system is powered).

With reference still to FIG. 7, computer system 700 also includes a network communication device 735, which is coupled to bus 710 for providing a communication link between computer system 700, and a network environment, e.g., network environment 600 of FIG. 6. As such, network communication device 735 enables central processor unit 701 to communicate with other electronic systems coupled to the network, e.g., network 600 of FIG. 6. It is noted that the present embodiment of network communication device 735 is well suited to be implemented in a wide variety of ways. In one example, network communication device 735 is coupled to an antenna and provides the functionality to transmit and receive information over a wireless communication interface, e.g., Bluetooth, IR (infra-red), RF (radio frequency), satellite and the like. In another example, network communication device 735 could be implemented as a modem, wired or wireless. In yet another example, network communication device 735 could be configured as a NIC (network interface card), wired or wireless.

Still referring to FIG. 7, network communication device 735, in an embodiment, includes an optional digital signal processor (DSP) 720 for processing data to be transmitted or data that are received via network communication device 735. Alternatively, processor 701 can perform some or all of the functions performed by DSP 720.

Also included in computer system 700 of FIG. 7 is an optional alphanumeric input device 706. In an implementation, device 706 is a keyboard. Device 706 can be physically coupled to computer system 700. Alternatively, device 706 may be wirelessly coupled to computer system 700. Alphanumeric input device 706 can communicate information and command selections to processor 701.

Computer system 700 of FIG. 7 also includes an optional cursor control or directing device (on-screen cursor control) 707 coupled to bus 710 for communicating user input information and command selections to processor 701. In another common implementation, on-screen cursor control device 707 is a mouse or similar pointing device.

Computer system 700 also contains a display device 705 coupled to the bus 710 for displaying information to the computer user.

Accordingly, embodiments of the present invention, as described herein with reference to FIGS. 1, 2, 3A-3B, 4A-4D and FIGS. 5-7, can be utilized to maintain a servo signal in an operating disk drive, in accordance with embodiments of the present invention.

Embodiments of the present invention, in the various presented embodiments, provide for maintaining a servo signal and preventing release of an actuator arm.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method for maintaining a servo signal in a shock event, said method comprising:
monitoring a shock event value, said shock event value generated by a shock sensor, said shock sensor operably coupled with a disk drive, said disk drive configured with an actuator arm having a suspension and slider coupled thereto;
detecting a variation in said shock event value associated with said slider; and
switching from a conductive link to said slider to another conductive link to another slider, said another slider coupled with another actuator arm in said disk drive.

2. The method as recited in claim 1 further comprising:
blocking said actuator arm coupled with said slider from an actuator release process.

3. The method as recited in claim 2 wherein said preventing further comprises;
blocking said actuator arm from performing a data surface contacting process.

4. The method as recited in claim 1 wherein said preventing further comprises;
checking that said another conductive link is operable.

5. The method as recited in claim 1 further comprising; and
ensuring that a signal, emitted from a data storage surface associated with said another slider, is sensed by said another slider.

6. The method as recited in claim 2 further comprising:
switching said conductive link from said slider to another conductive link for yet another slider coupled to said actuator arm, when said actuator arm is configured with a plurality of suspensions, wherein each of said plurality of suspensions comprise a slider.

7. The method as recited in claim 6 wherein said switching further comprises;
disabling said conductive link from said slider; and
enabling said another conductive link.

8. A system for maintaining a servo signal, said system comprising:
a disk drive, operable within a computer system, and having a suspension coupled to an actuator arm, wherein each actuator arm comprises a slider;
a servo shock monitor coupled to said disk drive; and
a channel switcher, coupled to said servo shock monitor, and configured to switch from a channel for said slider to another channel for another slider when said servo shock checker detects said slider losing a servo signal.

9. The system as recited in claim 8 further comprising:
an actuator release preventer configured to cause aborting of a release of said actuator arm having said slider during said losing a servo signal.

10. The system as recited in claim 9 wherein said actuator release preventer is configured to cause aborting of a contacting stop of said slider during said losing a servo signal.

11. The system as recited in claim 8 further comprising:
a servo signal ensurer to ensure said servo signal is established using said another channel and said another slider.

12. The system as recited in claim 8 wherein said hard disk further comprises:
a first actuator arm and a second actuator arm, said first and second actuator arms each having a first slider and a second slider.

13. The system as recited in claim 13 wherein said channel switch is further enabled to switch from a channel for said second slider of said first actuator arm to another channel for said first slider of said second actuator arm when said second slider of said first actuator arm loses said servo signal.

14. The system as recited in claim 12 wherein said channel switch is further enabled to switch from a channel for said second slider of said first actuator to another channel for said first slider of said first actuator arm when said second slider of said first actuator arm loses said servo signal.

15. In a computer-usable medium having computer-readable program code embodied therein, a computer-implemented method for maintaining a servo signal in a disk drive, said computer-implemented method comprising:
receiving a shock occurrence indicator from a shock sensor operably coupled with a disk drive coupled with a computer, said shock occurrence affecting a signal between an active slider coupled to an actuator arm of said disk drive and a data storage surface of said disk drive;
causing said actuator arm to not perform a release process in response to said signal being affected by said shock occurrence; and
disabling a conductive link to said active slider; and
enabling another conductive link, said another link to another slider, said another slider becoming an active another slider while said active slider becomes an inactive slider.

16. The computer-implemented method as recited in claim 15 further comprising;
performing a check of said another conductive link to ensure said another conductive link is operable.

17. The computer-implemented method as recited in claim 15 further comprising;
ensuring that a signal from another data storage surface is sensed by said another slider.

18. The computer-implemented method as recited in claim 15 wherein said causing further comprises;
causing said actuator arm to not perform a data storage surface contact process.

19. The computer-implemented method as recited in claim 15 further comprising:
receiving a shock occurrence indicator from a shock sensor operably coupled with said disk drive coupled with a computer, said disk drive configured with a first actuator arm and a second actuator arm, wherein said first actuator arm has a first slider and a second slider and said second actuator arm comprises a third actuator arm and a fourth actuator arm, said shock occurrence affecting said signal between said second slider of said first actuator arm coupled to an actuator arm of said disk drive and a data storage surface of said disk drive.

20. The computer-implemented method as recited in claim 19 further comprising:
disabling a conductive link to said second slider of said first actuator arm; and
enabling another conductive link, said another conductive link to said third slider of said second actuator arm.
